(19) United States
(12) Patent Application Publication
(10) Pub. No.: US 2025/0379291 A1
(43) Pub. Date: Dec. 11, 2025

(54) SYSTEMS AND METHODS FOR DIRECT CONVERSION OF CO2 INTO ELECTRICAL ENERGY BASED ON FE-CO2 BATTERY

(71) Applicant: University of North Texas, Denton, TX (US)

(72) Inventors: Wonbong Choi, Coppell, TX (US); Anil D. Pathak, Denton, TX (US)

(21) Appl. No.: 18/736,508

(22) Filed: Jun. 6, 2024

Related U.S. Application Data
(60) Provisional application No. 63/462,518, filed on Apr. 27, 2023.

(51) Int. Cl. H01M 12/08; H01M 4/02; H01M 4/38; H01M 4/86; H01M 4/90

(52) U.S. Cl. CPC H01M 12/08; H01M 4/38; H01M 4/8605; H01M 4/9083; H01M 2004/027; H01M 2004/8689

(57) ABSTRACT

Embodiments provide systems and methods for conversion of carbon dioxide (CO₂) to energy based on metal-CO₂ batteries. The disclosed power systems and methods utilize iron (Fe)-based CO₂ batteries that include a porous cathode (e.g., a carbon nanofiber (CNF) cathode) and an anode formed from Fe or Fe-alloy. In an aspect, the porous cathode may be coated with a catalyst to improve performance of the battery system. The disclosed battery systems offer direct CO₂ reduction by electron transfer via exposure of Fe ions (Fe⁺², Fe⁺³) from the anode to the CO₂ provided to the porous cathode, which is used as an efficient electrochemical energy conversion device for direct converting captured CO₂ into electrical energy without having additional energy consumption. The chemical reactions provided by the disclosed battery systems also facilitate generation of useful by-products in an energy efficient and environmentally friendly manner.

### CROSS-REFERENCE TO RELATED APPLICATIONS

The present application claims the benefit of priority from U.S. Provisional Application No. 63/462,518 filed Apr. 27, 2023 and entitled “SYSTEMS AND METHODS FOR DIRECT CONVERSION OF CO₂ INTO ELECTRICAL ENERGY BASED ON FE-CO₂ BATTERY,” the disclosure of which is incorporated by reference herein in its entirety.

### TECHNICAL FIELD

The present disclosure generally relates to power storage and discharge systems and more specifically, to systems for converting carbon dioxide (CO₂) to electrical energy.

### BACKGROUND OF THE INVENTION

Numerous efforts to reduce greenhouse gases (GHG), particularly CO₂, have been put forth as a potential means for combatting the climate crisis caused by increasing CO₂ concentrations in the atmosphere. Recently, CO₂ capture and long-term storage has been proposed as a mechanism to combat climate changes by preventing the release of CO₂. Transforming CO₂, such as CO₂ captured and stored CO₂, into other chemicals has also been proposed as a mechanism to reduce CO₂ release into the atmosphere. However, processes to convert CO₂ into other chemicals consumes a large amount of energy, which leads to additional pollution. Therefore, developing new technologies for carbon capture and utilization (CCU) without having additional energy consumption has become a challenge. Metal-CO₂ batteries such as Li—CO₂, Na—CO₂, and K—CO₂ have shown potential in terms of providing surplus electricity storage and effective CO₂ utilization. However, this battery chemistry has additional issues such as scarcity of active material (e.g., lithium) resources and high cost, as well as safety concerns.

### SUMMARY OF THE INVENTION

Embodiments of the present disclosure provide metal-CO₂ power systems capable of converting CO₂ into energy. For example, a metal-CO₂ power system according to the concepts disclosed herein may include a Fe—CO₂ battery. The Fe—CO₂ battery may include an anode formed from iron (Fe), Fe-alloys, or steel and a porous cathode, such as a cathode formed from a 3D carbon nanofiber material. In an aspect, the cathode may be coated with a catalyst. The battery also includes a electrolyte connecting the cathode and anode. Power may be generated based on a redox reaction at the anode, producing iron ions (Fe⁺², Fe⁺³) that pass from the anode to the cathode via the electrolyte.

The cathode may be exposed to CO₂, such as from a CO₂ capture source during operation of the battery. The Fe ions may interact with the CO₂ at the cathode to form by-products that may be collected. In an aspect, the electrolyte may be aqueous or non-aqueous, and the composition of the electrolyte may be utilized to control at least a portion of the byproducts generated during operation of the disclosed power systems. For example, the byproducts may include iron carbonate (FeCO₃), hydrogen (H₂), and carbon powders as non-limiting examples.

The disclosed power systems are also configured to facilitate continuous operations by utilizing removable/replaceable anodes and cathodes. For example, the anode may become less efficient due to the redox reaction or other factors that may limit the production of Fe ions. As the efficiency of the anode declines, the anode may be removed and replaced with a new anode. The removed anode may be refinished, such as to remove rust of other imperfections on the surface(s) of the anode and other operations (e.g., polishing), thereby providing a good surface of Fe suitable for further use in the battery. Similarly, the cathode may be removed to facilitate collection of the by-products produced by the battery. In an aspect, the power system may be provided with a conveyor system for removing and replacing cathodes and/or anodes within the batteries disclosed herein.

Once the by-products are removed from the cathode, the cathode may be reused with the battery. The by-products generated by the battery may be processed into additional by-products, such as methane, hydrogen, metal carbonate, etc. Generating the by-products and secondary by-products (e.g., by-products created by processing the by-products collected from the cathode) in the manner disclosed herein may provide an energy efficient and environmentally friendly (i.e., little or no environmental impact with respect to CO₂ emissions) mechanism for obtaining valuable materials, such as FeCO₃, H₂, carbon powders, and methane (e.g., by processing FeCO₃).

As shown above, the present disclosure provides various configurations for CO₂-based energy conversion systems based on one or more Fe—CO₂ batteries. As can be appreciated from the examples described above, Fe—CO₂ batteries in accordance with the present disclosure may include porous cathodes (e.g., 3D CNF cathodes), which may be coated with a catalyst, and an anode formed from Fe, Fe-alloys, or steel, where the anode is connected to the cathode by electrolyte, as described above. The disclosed Fe—CO₂ batteries of the present disclosure enable direct CO₂ reduction by electron transfer on the (catalysts-deposited) cathode, thereby providing an efficient electrochemical energy conversion device for directly converting captured CO₂ into electrical energy without having additional energy consumption. Additionally, the disclosed CO₂ power systems enable generation of valuable by-products (FeCO₃, H₂, carbon powders, etc.) and/or processed in an energy efficient manner to generate valuable by-products (e.g., CH₄).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram of a system for converting CO2 to electrical energy in accordance with aspects of the present disclosure;

FIG. 2 is a block diagram illustrating exemplary aspects for continuous operation of power system in accordance with aspects of the present disclosure;

FIGS. 3A and 3B are a block diagram illustrating another exemplary power system configured in accordance with aspects of the present disclosure;

FIG. 4 is a block diagram illustrating a process for generating electrical power using an Fe—CO2 battery in accordance with aspects of the present disclosure;

FIG. 5 is a block diagram illustrating an exemplary embodiment of a metal-CO2 battery having an aqueous electrolyte in accordance with aspects of the present disclosure;

FIG. 6 is a block diagram illustrating an exemplary embodiment of a metal-CO₂ battery having a non-aqueous electrolyte in accordance with aspects of the present disclosure;

FIG. 7 is a block diagram illustrating an exemplary process for recycling iron anode, and generating methane using by-products obtained from a metal-CO2 battery in accordance with aspects of the present disclosure;

FIG. 8 shows diagrams illustrating a process for catalysts (e.g., MoS₂) deposition on CNF and exemplary details of a metal-CO₂ battery in accordance with the present disclosure;

FIGS. 9A-9D are diagrams illustrating performance metrics for a metal-CO2 battery in accordance with the present disclosure;

FIGS. 10A-10D are diagrams illustrating additional performance metrics for a metal-CO2 battery in accordance with the present disclosure; and

FIG. 11 is a flow diagram of an exemplary method for generating both power and byproducts in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

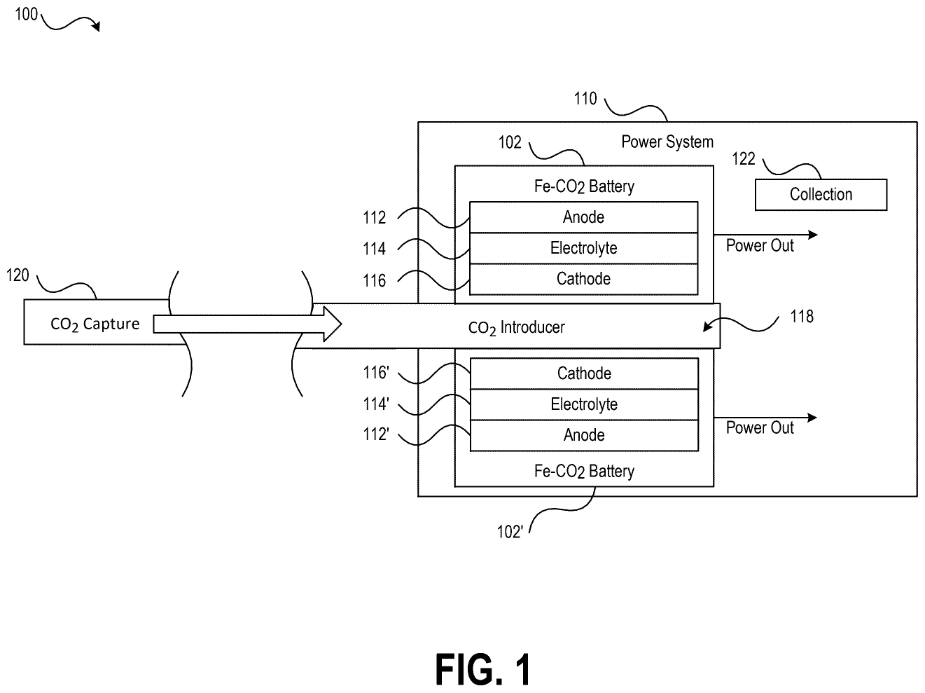

Referring to FIG. 1, a block diagram of a system for conversion of CO₂ to energy in accordance with aspects of the present disclosure is shown as a system 100. As shown in FIG. 1, the system 100 includes a power system 110 including an iron (Fe) CO₂ battery 102 having an anode 112, an electrolyte 114, and a cathode 116. In accordance with aspects of the present disclosure, the anode 112 may be formed of Fe, Fe-alloys, steel, or Fe-based compounds (e.g., Fe₃O₄, FeCO₃). Forming the anode 112 from such materials is beneficial since such materials are orders of magnitude more abundant, resulting in low cost, and are also compatible with standard manufacturing processes used in Li-ion battery chemistry. In an aspect, the anode 112 may include an additive to reduce the rate of hydrogen evolution and increase the overall efficiency of the cell. The additive may form 1-10% of the anode 112 by weight or volume. The additive may be Bi₂S₃, Bi₂O₃, FeS, Na₂S, or CNT, as non-limiting examples. To increase the utilization of anode 112 and access of the electrolyte 114, a Fe nanoparticle or 3D structured Fe anode can be used. To avoid or reduce passivation (i.e., rusting) of the anode 112, the anode 112 may be modified with a conducting (carbon, graphene)/non-conducting material coating (e.g., Polymer, TiO₂).

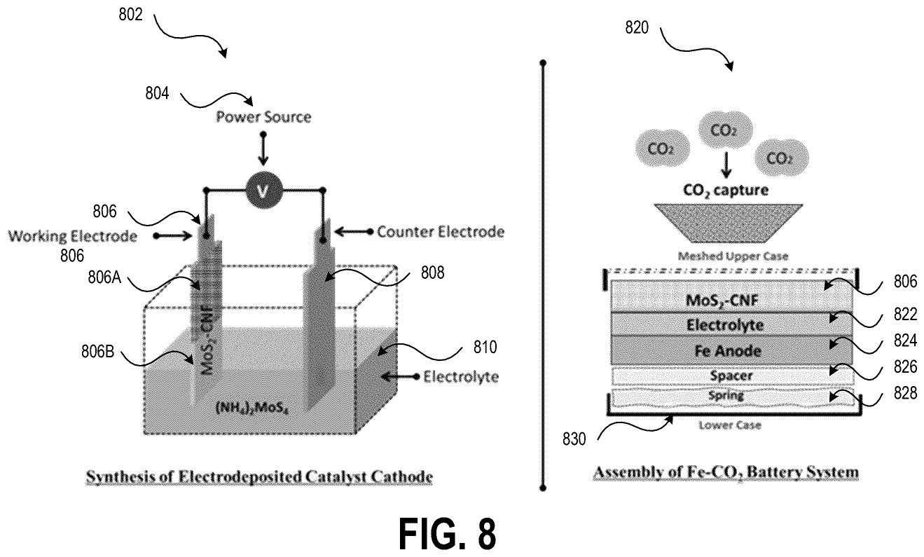

The cathode 116 may be formed of a porous material. For example, the cathode 116 may be formed from a carbon nanofiber material. In an aspect, the cathode 116 may be coated with a catalyst. An exemplary process for depositing the catalyst on the cathode 116 is illustrated and described below with reference to FIG. 8.

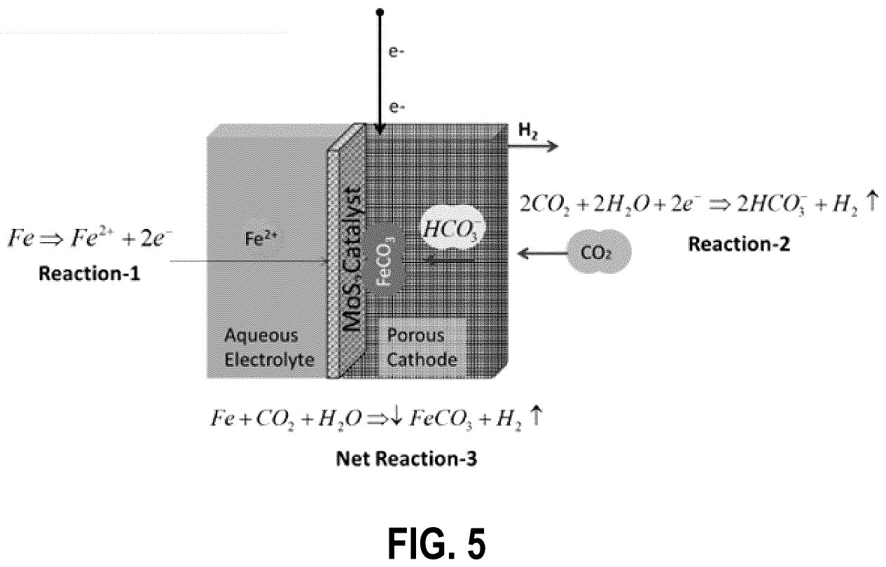

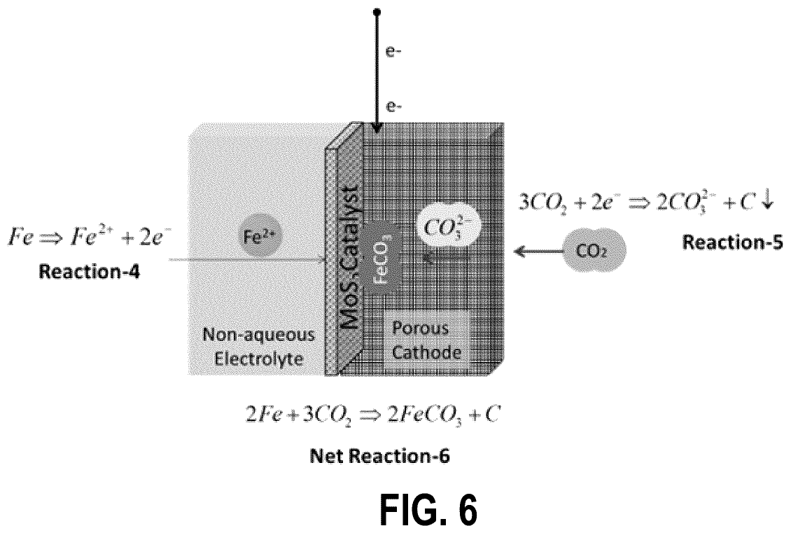

The electrolyte 114 may be a water-based electrolyte, as shown in FIG. 5. As a non-limiting example, the electrolyte may include iron (II) acetate, iron nitrate, iron chloride, iron sulfate, iron iodide, sodium chloride, potassium hydroxide, sodium hydroxide, or a combination thereof, as non-limiting examples, and water as a solvent. The use of aqueous electrolytes makes the battery less energy dense while also providing safety and sustainability. However, batteries in accordance with the present disclosure are not limited to use of aqueous electrolyte. For example, Fe corrodes and self-discharges rapidly in aqueous electrolytes, which may reduce the performance of the battery more quickly due to corrosion of the anode. As an alternative to use of aqueous electrolytes, batteries in accordance with the present disclosure may also be formed with non-aqueous electrolytes, such as a carbonate/ether based solvent along with iron salt (Fe₂(SO₄)₃, Fe(ClO₄)₂ in TEGDME/DMSO solvent. Exemplary aspects of a battery having a non-aqueous electrolyte in accordance with the concepts disclosed herein are shown in FIG. 6. Non-aqueous electrolytes in Fe—CO₂ batteries in accordance with the present disclosure lead to a wide electrochemical window, and more energy dense and sustainable iron electrodes. In another aspect, the present invention relates to a Fe—CO₂ battery system wherein solvent for electrolyte is selected from but not limited to organic, and inorganic or combinations of other organic, inorganic electrolyte such as ethylene carbonate (EC), tetraethylene glycol dimethylether (TEGDME), 1,3-dioxolane (DOL), 1,2-dimethoxyethane (DME), poly(ethylene glycol)dimethyl ether (PEGDME), diethylene glycol dibutyl ether (DEGDBE), sulfone, sulfolane, dimethyl carbonate (DMC), methylethyl carbonate (MEC), vinylene carbonate (VC), allyl ethyl carbonate (AEC), diethyl carbonate (DEC), ethyl propionate, methyl propionate, propylene carbonate (PC), acetonitrile (AN), 2-ethoxyethyl ether (EEE), ethyl acetate (EA), methyl formate (MF), toluene, methyl acetate(MA), ethylene glycol dimethyl ether, dimethyl cellosolve, dimethyl ether (PEGDME), diethylene glycol dibutyl ether (DGDE), fluoroethylene carbonate (FEC), or a combination thereof.

As shown in FIG. 1, the power system 110 also includes a CO₂ introducer 118. The CO₂ introducer 118 may be in fluid communication with a source of CO₂, shown in FIG. 1 as CO₂ capture source 120. The CO₂ source 120 may be configured to extract CO₂ from industry exhaust, atmospheric CO₂, or other potential sources. The CO₂ introducer 118 is configured to provide CO₂ from the source of CO₂ to the porous cathode 116 of the Fe—CO₂ battery 102, and the Fe—CO₂ battery 102 is configured to generate electrical power in response to providing CO₂ to the porous cathode 116 via the CO₂ introducer 118. For example, the CO₂ introducer 118 may deliver CO₂ from the CO₂ capture source 120 to a CO₂ inlet (not labelled in FIG. 1) of the battery 102, where the CO₂ is exposed to the cathode 116, which is porous. In an aspect, the CO₂ introducer 118 may include a valve or other mechanism (not shown in FIG. 1) for controlling the volume of CO₂ provided to the battery 102. As a result of exposing the cathode 116 to CO₂, the battery 102 produces electrical power via chemical reactions taking place within the battery 102.

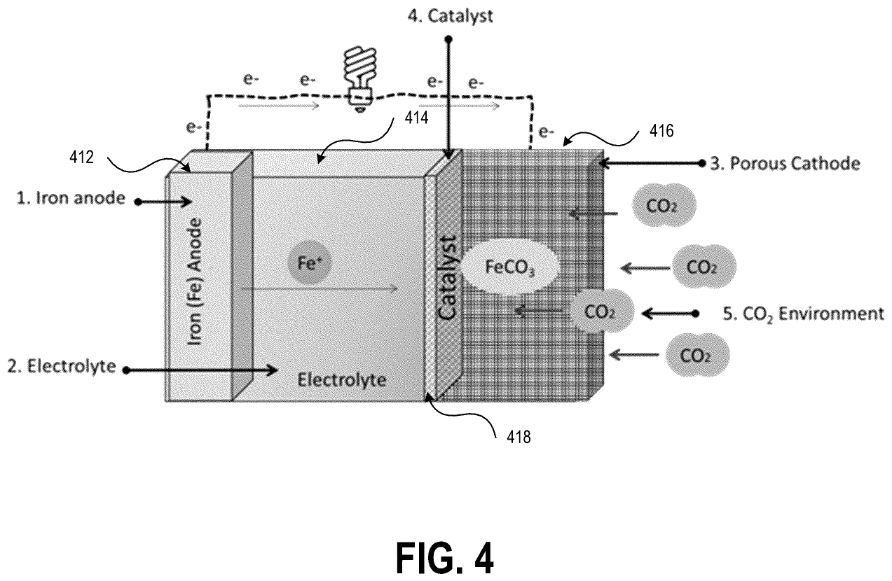

For example and referring to FIG. 4, a block diagram illustrating a process for generating electrical power using an Fe—CO₂ battery in accordance with aspects of the present disclosure is shown. As shown in FIG. 4, an Fe—CO₂ battery system in accordance with aspects of the present disclosure includes an iron-based anode 412 (e.g., an Fe, Fe-alloy, or steel anode), a porous cathode 416, and an electrolyte 414. In an aspect, the anode 412 may correspond to one or both of the anodes 112, 112′ of FIG. 1, the electrolyte 414 may correspond to one or both of the electrolytes 114, 114′ of FIG. 1, and the cathode 416 may correspond to one or both of the cathodes 116, 116′ of FIG. 1. Unlike current lithium-ion battery systems, which are closed systems, the porous carbon-based cathode 416 acts as cathode material and may include or be supported by a catalyst particles/layer 418. In an aspect, the catalyst 418 may be formed from two dimensional (2D) transition metal dichalcogenides (2D TMDs), such as MoS₂, WS₂, MoWS₂ etc. In an aspect, the catalyst 418 may be formed from one or more Group II metals, such as alkaline earth, Be, Mg, Zn. Cd or Hg, one or more Group IV metals/transition metals, such as Co, Ni. Cu, Ti. Zr. Hf, Ge, Sn or Pb, one or more Group V metals, such as V, Nb, Ta. As, Sb or Bi, one or more Group VIII metals, such as iron or platinum, one or more Group I metals, such as alkali, Ag, Au or Cu, other metal (e.g., Cr, Mo, Sc, Y, Al, Ga, In) and/or their oxides (e.g., Mn₂O₃, ZnO, NiO, SiO2, TiO₂, WO₃, MgO, CaCO₃, ZrO₂, Al₂O₃, Fe₂O₃, CO₃O₄, etc.) and/or their sulfides (e.g., CuS, PbS, TiS₂, WS₂), or derivatives thereof.

At the surface of the anode 412, oxidation of iron takes place, generating iron ions (Fe⁺). At surface of the cathode 416, reduction of CO₂ takes place to form carbonate ions. The redox reaction of the anode 412 releases the iron ions (Fe⁺), which are constantly transported through the electrolyte 414 to the cathode 416. The iron ions react with CO₂ molecules passing through the porous cathode 416, producing a metal carbonate (e.g., iron carbonate (FeCO₃)) and solid carbon, or other by-products within or on the surfaces of the porous cathode 416 and partially on the anode 412. It is noted the nature of discharge product formed may be dependent on the electrolyte 414 used within the Fe—CO₂ battery.

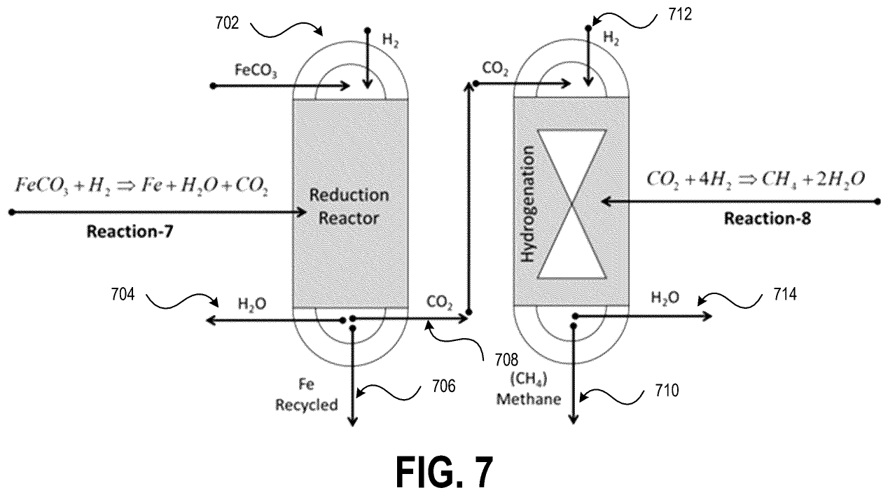

To illustrate, the power system may be configured to generate methane (CH₄) by utilizing electrolytes formed using ionic liquid solvents selected from but not limited to imidazolium, sulfonium, pyrrolidinium, pyridinium, piperidinium, ammonium, and phosphonium, and different inorganic or organic anions, including halides (e.g., chloride [Cl⁻], bromide [Br], fluoride ([F⁻]), iodide [I—]), acetate, tetrafluoroborate [BF^{4 -}], hexafluorophosphate [PF⁶⁻], tetrachloroaluminate [AlCl⁴⁻], bistriflimide [(CF₃SO₂)₂N]—, bis(trifluoromethanesulfonyl) imide [TFSI⁻], ethyl sulfate [EtSO⁴⁻], dicyanamide [N(CN)²⁻], and thiocyanate [SCN⁻], Nitrate (NO₃), amino acid, formic acid, nitrate, and the like. Additionally, or alternatively, the power systems may be configured to generate iron carbonate (FeCO₃), hydrogen (H₂), or other compounds, such as carbon powders, as illustrated by the chemical reactions shown in FIG. 5 (i.e., showing chemical reactions for producing FeCO₃ and H₂ using an aqueous electrolyte) and FIG. 6 (i.e., showing chemical reactions for producing FeCO₃ and carbon powders using a non-aqueous electrolyte). Such by-products (e.g., FeCO₃ and H₂) may be processed to produce methane in an environmentally friendly manner, as described and illustrated herein with reference to FIG. 7.

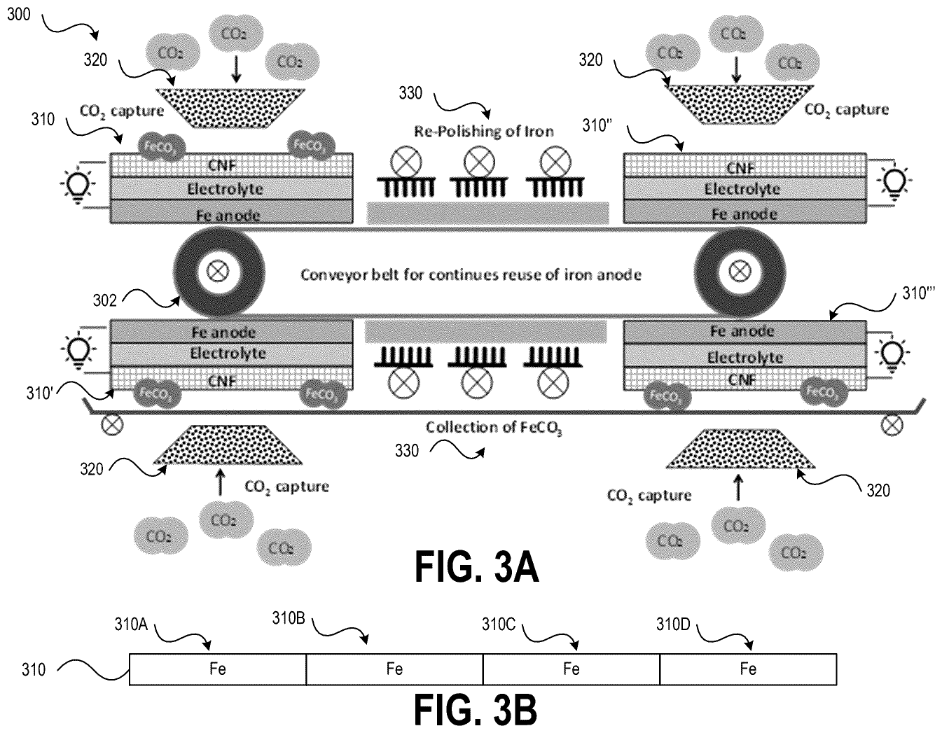

As briefly explained above, chemical reactions used to generate power within the power system 110 may generate by-products, such as FeCO₃. In an aspect, the power system 110 may include a collection system 122 for capturing the one or more by-products of the chemical reaction associated with the Fe—CO₂ battery 102. For example, the one or more by-products may include iron carbonate (FeCO₃), carbon powders, or both. The one or more by-products may be formed on the cathodes 116, 116′. The collection system 122 may be configured to extract the one or more by-products from the cathode 116. For example, the cathode 116 may be removable and once removed (and replaced by a new cathode), the removed cathode 116 may be provided to the collection system 122. Once received at the collection system 122, the by-products may be removed, such as by scraping the by-products from the surface(s) of the cathode 116 or via another technique, as described in more detail below with reference to FIGS. 3A and 3B.

In an aspect, the power system 110 may include multiple Fe—CO₂ batteries. For example, in FIG. 1 another Fe—CO₂ battery 102′ is shown and includes an anode 112′, an electrolyte 114′, and a cathode 116′, which may have the same configuration as described above with reference to the anode 112, the electrolyte 114, and the cathode 116. The Fe—CO₂ battery 102′ may also be configured to generate electrical power using CO₂ provided to the porous cathode 116′ via the CO₂ introducer 118. It is noted that while FIG. 1 illustrates the power system 110 as including two Fe—CO₂ batteries, power systems in accordance with aspects of the present disclosure may include a single Fe—CO₂ battery, two Fe—CO₂ batteries, or more than two Fe—CO₂ batteries according to the particular design of the power system, the power output goals, as well as the volume of carbon available from carbon source 120.

It should be appreciated from the foregoing that above-described power systems provide a CO₂ reduction system based on a CO₂ fixation and energy conversion mechanisms configured to transform CO₂ gases into electrical energy directly without using additional electricity/energy input. Thus, the power system 100 is sustainable in terms of continuous utilization of CO₂, production of electricity and other valuable products (e.g., methane and hydrogen) in a CO₂ environment, thereby overcoming the deficiencies of prior systems for generating by-products for carbon capture which consume high amounts of energy to convert CO₂ into useful by-products.

Additionally, it is noted that Fe—CO₂ battery-based power systems in accordance with aspects of the present disclosure can produce high energy density (e.g., Fe—CO₂ battery can offer ˜485 Wh/kg) while reducing safety and environmental impact concerns associated with prior battery systems, such as lithium-ion-based batteries. For example, because the Fe—CO₂ batteries disclosed herein may be formed from materials abundant in nature, such as Fe and carbon, the various embodiments of power systems disclosed herein can be used as safe power sources for practical applications. Moreover, the disclosed Fe—CO₂ batteries provide high energy density while utilizing an environmentally-friendly and green (no toxic/pollutant emission) approach for handling CO₂ emissions and the direct conversion of CO₂ emissions into electric energy. The disclosed power systems also provide a competitive and cheaper technology for carbon capture applications and open an industrial, scalable route for CO₂ fixation and electrical energy generation. For example, the power system 100 of FIG. 1 and other power systems disclosed herein can capture 1 ton of CO₂ with usage of approximately 1.23 tons of iron at the extremely low cost (a cost of iron ˜$85/ton). An additional advantage provided by power systems of the present disclosure is the use of metals and CO₂ chemistry to provide valuable by-products, such as metal carbonates, hydrogen, methane, and carbon powder while generating electrical power from such reactions. Such an approach provides a safe process for CO₂ capture and utilization using non-toxic chemicals, thereby eliminating the need to generate non-degradable/hazardous waste as in existing approaches for generating such by-products.

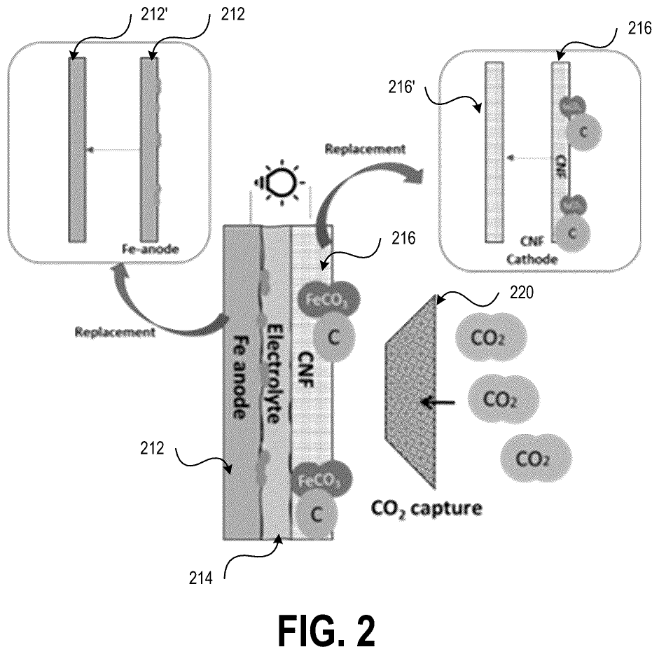

Referring to FIG. 2, a block diagram illustrating exemplary aspects for continuous operation of power system in accordance with aspects of the present disclosure is shown. In particular, FIG. 2 illustrates a power system including a Fe—CO₂ battery for converting CO₂ into electrical power in accordance with the concepts disclosed herein. As explained above with reference to FIGS. 1 and 4, the Fe—CO₂ battery includes an anode 212, an electrolyte 214, and a cathode 216, which may be similar to the anode 112, electrolyte 114, and cathode 116 of FIG. 1. As explained above, conversion of CO₂ to electrical power by batteries in accordance with the present disclosure may produce one or more by-products, such as iron carbonate, carbon powders, or other by-products. The by-products may be formed on the surface(s) of the cathode 216 and the cathode(s) may be periodically removed to collect the by-product(s) formed thereon. For example, a cathode 216 may be removed and replaced with a new cathode 216′ (e.g., an unused cathode, a cathode from which the by-products have already been collected, etc.). This may allow a used cathode (e.g., a cathode having by-product formed thereon) of the Fe—CO₂ battery to be removed and replaced with a new cathode, thereby allowing the Fe—CO₂ battery to continue generating power through conversion of CO₂ from CO₂ source 220 (e.g., the CO₂ source 120 of FIG. 1) and allowing the by-products to be collected from the used cathode(s) (e.g., using the collection system 122 of FIG. 1).

Similarly, FIG. 2 illustrates that the anode 212 of the Fe—CO₂ battery may be removable/replaceable. For example, the anode 212 may be removed and replaced by an anode 212′. Such a configuration enables the Fe—CO₂ battery to be operated in a continuous manner to produce electrical power through conversion of CO₂ from CO₂ source 220 while enabling the anode to be refurbished/replaced to maintain a desired level of performance. That is, the anode can be maintained in good working order to enable Fe ions (Fe⁺) to continuously pass through the electrolyte to the cathode 216. It is noted that although not shown in FIG. 2, the cathode 216, 216′ may be coated with a catalyst, as described above with reference to the catalyst 418 of FIG. 4.

Referring to FIG. 3A, a block diagram of another exemplary a power system configured in accordance with aspects of the present disclosure is shown as a power system 300. As shown in FIG. 3A, the power system 300 includes multiple Fe—CO₂ batteries 310, 310′, 310″, 310′″, each having a structure (e.g., anode, cathode, electrolyte, and catalyst) described above with reference to the batteries of FIGS. 1, 2, and 4. Additionally, each of the Fe—CO₂ batteries 310, 310′, 310″, 310′″ may be configured to generate electrical power in response to exposure of the cathodes to CO₂, such as from CO₂ source(s) 320 (e.g., a carbon capture source provided to the batteries using a CO₂ introducer 118 of FIG. 1).

The power system 300 also includes a conveyor system 302 and one or more anode refurbishing units 330. The conveyor system 302 may include one or more conveyor belts to move the anode(s) out of the battery to facilitate cleaning the anodes using the refurbishing unit(s) 330. For example, the anode(s) may rust as a result of chemical processes within the battery. By moving the anode(s) out of the battery using the conveyor system 302, the refurbishing unit(s) 330 may be used to clean and polish the anodes, removing any rust, contaminants, or other imperfections present on the surface of the anode.

As explained above with reference to FIG. 2, when the anode(s) is removed, another anode may be placed in each of the batteries 310, 310′, 310″, 310′″ to facilitate continuous operation of the power system 300. For example and referring to FIG. 3B, a plurality of anodes 310A-310D are shown. The anodes 310A-310D may correspond to the anodes of the Fe—CO₂ batteries 310, 310″. When the anodes 310A, 310C need to be cleaned/refurbished or replaced, the conveyor system 302 may move the anodes 310A, 310C out of the Fe—CO₂ batteries 310, 310″, respectively, and move the anodes 310B, 310D into the Fe—CO₂ batteries 310, 310″, thereby enabling continuous operation of the Fe—CO₂ batteries 310, 310″ despite the anodes 310A, 310C being removed for cleaning. That is to say, while the anodes 310A, 310C are being cleaned, the Fe—CO₂ batteries 310, 310″ may continue to operate with the anodes 310B, 310D. Similarly, when the anodes 310B, 310D are removed for cleaning the conveyor system 302 may be used to move the anodes 310B, 310D out of the Fe—CO₂ batteries 310, 310″ and move the anodes 310A, 310C into the Fe—CO₂ batteries 310, 310″ to continue operations for power generation. It is noted that while the example described above relates to the Fe—CO₂ batteries 310, 310″, similar operations may be performed with respect to the anodes of the Fe—CO₂ batteries 310′, 310′″. Additionally, where one or more of the anodes 310A-310D become unusable (e.g., due to corrosion or after being refurbished several times), new anodes may be provided to replace the unusable anodes, thereby facilitating a longer lifespan of the batteries 310, 310′, 310″, 310′ for power generation.

Referring back to FIG. 3A, the conveyor system 302 may also be used to remove and replace the cathodes of the Fe—CO₂ batteries 310, 310′, 310″, 310′″. As with the examples above related to the anodes, the conveyor system 302 may be used move active cathodes (e.g., cathodes that were being used for power generation) out for cleaning and/or by-product collection and to move new cathodes (e.g., unused cathodes and/or cathodes from which by-products have been collected) into the Fe—CO₂ batteries 310, 310′, 310″, 310′″, thereby enabling power generation to continue while the previous active are undergoing cleaning and/or for by-product collection.

In the exemplary embodiment of FIGS. 3A and 3B, the captured environmental or industrial CO₂ is introduced into the energy conversion system by a CO₂ flow inlet (e.g., via an introducer similar to the CO₂ introducer 118 of FIG. 1) in fluid communication with a source of CO₂ 320. As explained above with reference to FIG. 4, Fe-ions are directed towards the catalysts-deposited cathode, where CO₂ gases are dissociated by the catalyst deposited on the cathode and form carbonate ions at the cathode electrode/electrolyte interface. Further, the reaction between carbonate and Fe-ions takes place at the cathode surface, which may be coated by the catalyst, and resultant by-products of FeCO₃ and solid carbon are deposited over the surface(s) of the cathode. The conveyor system 302 enables the anodes and cathodes to be removed, cleaned, and re-used, while also facilitating continuous operation of the power system 300 for power generation.

In the refurbishing unit(s) 330, the anode may be ground and polished such that there is continuous fresh iron surface exposed in the electrolyte to facilitate strong electrochemical reaction (e.g., generation of Fe⁺ ions). Similarly, the cathode may be cleaned and by-products collected. As needed, new (i.e., previously unused) anodes and cathodes may replace old anodes and cathodes that have been contaminated with reactants. The above-described processes may facilitate continuous operation of the power system, re-use of anodes and cathodes through refurbishment, as well as collection of by-products. Moreover, the by-products may be produced in an energy efficient manner as compared to current processes for producing by-products similar to those produced by the reactions achievable using power systems in accordance with the present disclosure.

As can be appreciated from the foregoing, power systems and batteries in accordance with the present disclosure may be utilized in a variety of different settings and use cases. For example, FeCO₂ batteries in accordance with the present disclosure may be utilized to generate, store, and provide power to at least a portion of a site where CO₂ is produced and captured, which may include oil and gas facilities or other locations and industries. Additionally, FeCO₂ batteries in accordance with the present disclosure may be used as energy storage devices for space applications, such as for exploration of Mars/Venus (e.g., to power surface landers, rovers, human exploration, and the like) due to the improved safety as compared to Li-ion batteries and power storage systems. It is noted that the exemplary applications and use cases described above have been provided by way of illustration, rather than by way of limitation and that power storage systems in accordance with the present disclosure may be readily applied to other use cases for which batteries providing enhanced safety and sustainability may be desired (e.g., aircraft power systems, electric vehicles, etc.).

Referring to FIG. 7, a block diagram illustrating an exemplary process for generating methane using by-products obtained from a battery in accordance with aspects of the present disclosure is shown. As explained above, a by-product of generation of electrical power using a battery in accordance with the present disclosure may be FeCO₃, which may be collected as described above. The Fe—CO₃ may be recycled by reduction reaction with hydrogen. As shown at 702, FeCO₃ and hydrogen (H₂) are fed to a reduction reactor. Within the reduction reactor the H₂ reduces the FeCO₃ to iron metal 706 with water (H₂O) 704, and CO₂ 708 as byproduct (reaction-7). The CO₂ 708 generated via reaction 7 and H₂ 712 may be fed to a hydrogenation chamber and converted to methane (CH₄) 710 and water (H₂O) 714 via reaction-8. As shown in FIG. 7 and described above, batteries operating in accordance with the present disclosure may facilitate generation of by-products, such as FeCO₃ that may be collected. Such by-products may then be used to generate valuable products, such as Fe and CH₄, in a manner that is cost and energy efficient and with low environmental impact.

Referring to FIG. 8, diagrams illustrating exemplary details of a metal-CO₂ battery in accordance with the present disclosure are shown. As shown in FIG. 8, at 802 a catalyst may be used to enhance the reaction kinetics of charge and discharge reactions in metal-CO₂ batteries. Metals which are catalytically active and electrically conductive such as Pd, Pt, Ag, Au, and the like can be used as the catalyst according to some aspects of the present disclosure. However, applying such metals to porous cathodes (e.g., Au catalyst on carbon nanofiber mesh cathodes) may be inefficient due to high costs and metal processing requirements. Accordingly, the catalyst may be formed from a two-dimensional transition metal dichalcogenides (2D TMDs), such as MoS₂, WS₂, MoWS₂, which exhibit property tunability between 1T (metallic) phase and 2H (semiconducting) phase or mixtures of these phases. The 1T phase structure has high catalytic activity due to its rich metallic phase and better electron conductivity, whereas the 2H phase structure also provides catalytic effect with high metal-ion conductivity. As can be appreciated from the foregoing, using 2D TMDs catalysts may play a significant role in enhancing the electrochemical reaction kinetics (e.g., CO₂ reduction reaction (CORR) and CO₂ evolution reaction (COER)) by reducing the cell overpotential, thereby, minimizing the energy loss during charge and discharge with efficient reversible Fe—CO₂ batteries.

To produce catalyst-enhanced cathodes for use in Fe—CO₂ battery devices according to the present disclosure, a 2D TMD(s) catalyst (e.g., MoS₂) may be electrodeposited on the porous cathode, such as a carbon nanofiber (CNF) mesh, as shown in FIG. 8, at 802. During electrodeposition, a catalyst coating is deposited on the cathode by placing the cathode (e.g., a working electrode 806 formed of CNF) in an electrolyte bath 810, which may be a solution including (NH₄)₂MoS₄. A counter electrode 808 (e.g., a platinum counter electrode) may also be placed in the electrolyte bath 810, and a power source 804 may provide a source of potential to the working electrode 806 and counter electrode 808 to promote the electrodeposition process to transform the porous cathode 806A into a catalyst-coated porous electrode 806B. In an aspect, the catalyst that is deposited onto the cathode 806 may be selected from 2D TMDs (e.g., MoS₂, WS₂, MoWS₂ etc.), Group II metals (e.g., alkaline earth, Be, Mg, Zn, (d or H-g), Group IV metal/transition metals (e.g., Co, Ni, Cu, Ti. Zr. Hf, Ge, Sn, or Pb), Group V metals (e.g., V. Nb, Ta, As, Sb, or Bi), Group VIII metals (e.g., Fe or platinum group), Group I (e.g., alkali, Ag, Au or Cu), other metals (e.g., Cr, Mo, Sc, Y, Al, Ga, In) their oxides (e.g., Mn₂O₃, ZnO, NiO, SiO2, TiO₂, WO₃, MgO, CaCO₃, ZrO₂, Al₂O₃, Fe₂O₃, CO₃O₄, etc.) or their sulfides (e.g., CuS, PbS, TiS₂, WS₂), and other derivative compounds of the above-identified metals.

Once the catalyst coating is applied to at least a portion of the porous cathode 806, the cathode 806 may be used to form a battery in accordance with the present disclosure, such as the Fe—CO₂ batteries described above with reference to FIGS. 1, 2, and 4. A non-limiting example of an Fe—CO₂ battery structure is shown at 820 of FIG. 8, and includes a case 830. A spring 828 may be placed in the bottom of the case, followed by a spacer 826 that sits between the spring 828 and the anode (e.g., an Fe anode). The cathode 806 may then be placed in the case with an electrolyte 822 disposed between the anode 826 and the cathode 806. Disposing the porous cathode 806 on an outer surface of the battery may enable exposure of the battery to form CO₂ from a carbon capture source, as described above, which enables the battery to generate electrical power. Such positioning may also enable the removal of the porous cathode 806 to facilitate collection of by-products, as described above. It is noted that while FIG. 8 illustrates the anode 824 as having a spacer and spring on one side of the anode, in some implementations the anode 824 may be an outer layer (e.g., the spring and spacer are omitted) to facilitate removal and refurbishment/replacement of the anode 824, as described above.

As can be appreciated from the foregoing, Fe—CO₂ battery and power systems in accordance with the present disclosure provide an effective mechanism for producing energy from CO₂. Such power systems also show great promise and potential in terms of energy storage, greenhouse CO₂ fixation and generation of valuable products, as explained above. It has been also observed that the CO₂ reduction reaction (CRR) and CO₂ evolution reaction (CER) at the cathode require higher overpotential (charging) than that of the anode reaction (discharging) metal-CO₂ battery chemistry, thereby providing higher energy efficiency as compared to other CO₂-based power systems. Additionally, another important concern is limited electronic conductivity of the electrodes, which can limit the overall charge/discharge rate of the battery, and therefore, lower the efficiency of the system. The batteries disclosed herein make use of conductive 3D carbon nano fiber (CNF) cathodes or other conductive carbon-based materials (e.g., CNT, CNF, graphene or graphene oxides, carbon nanoparticles etc.) to overcome the rate performance issue of some prior metal-CO₂ batteries.

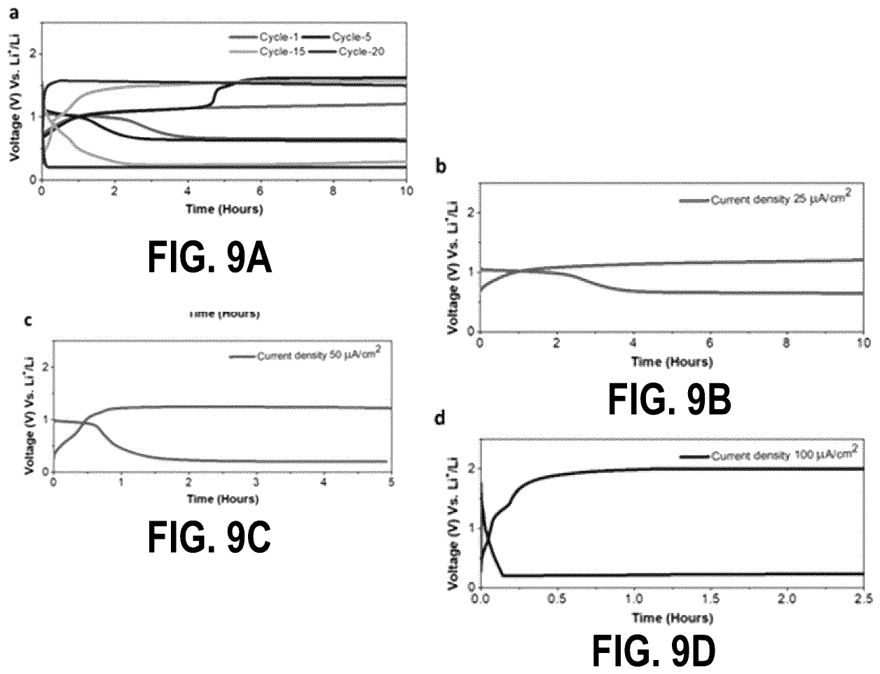

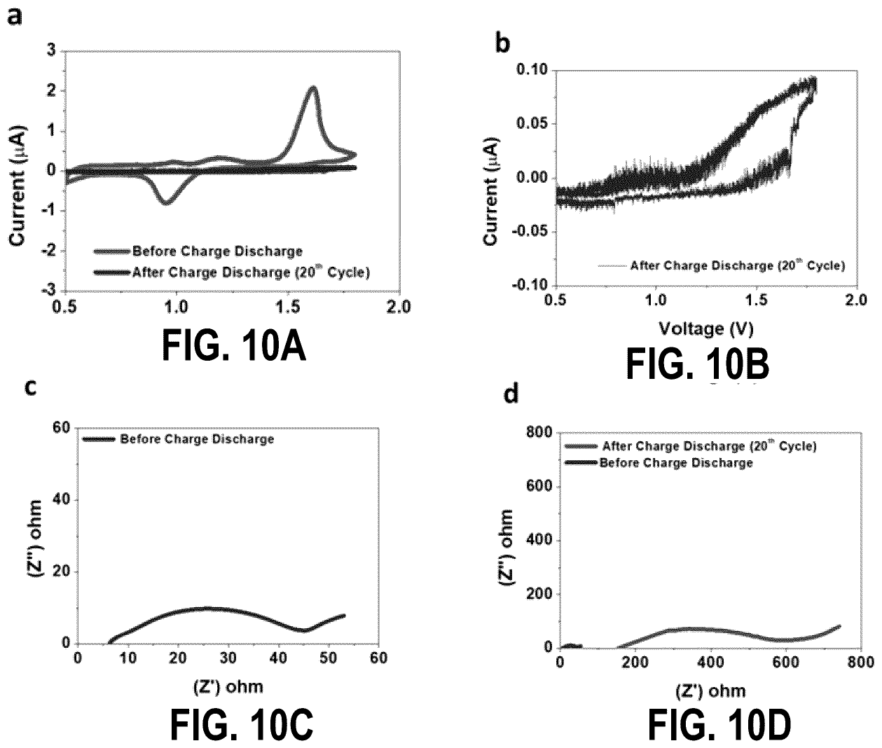

Referring to FIGS. 9A-9D, diagrams illustrating electrochemical performance of a power system in accordance with the present disclosure are shown. In particular, FIG. 9A shows charging/discharging characteristics of an Fe—CO₂ battery system operated in a CO₂ environment for 20 cycles. In FIGS. 9B-9D, diagrams illustrating charging/discharging characteristics of Fe—CO₂ battery systems operating at current densities of 25 μA/cm², 50 μA/cm², and 100 μA/cm², respectively are shown. The charge/discharge tests were conducted in the voltage range of 0.2-5.0 V (vs. Fe⁺/Fe) with the cutoff capacity of 250 mAh g⁻¹ at a current density of 25 μA/cm². All the specific capacity and current densities were calculated based on weight of catalyst material and area of active material. The Fe—CO₂ battery systems used to generate the diagrams of FIGS. 9A-9D (and FIGS. 10A-10D) were formed using a CR2032 coin cell with porous cathode according to the structure illustrated at 820 in FIG. 8, and placed in CO₂ environment. The diagram of FIG. 9A compares the galvanostatic reversible charge/discharge for an Fe—CO₂ battery system before and after 20 charge/discharge cycles. The Fe—CO₂ battery system had an open-circuit voltage (OCV) of ˜1.1 V. The Fe—CO₂ battery system had high initial discharging potential of ˜0.65 V with cutoff capacity of 250 mAh g⁻¹ operated for 10 hours. The overpotential of Fe—CO₂ batteries was approximately ˜0.6 V at the 1st cycle and increased to 1.3 V at the 20th cycle. Galvanostatic discharge/charge performance was also compared at different current densities, specifically current densities of 25 μA/cm², 50 μA/cm², and 100 μA/cm², respectively. The overpotential of the Fe—CO₂ battery was approximately ˜0.6 V when operated at a current density of 25 μA/cm². Comparatively, the overpotential of the Fe—CO₂ battery was 1.0 V and 1.8 V operated at a current density of 50 μA/cm² and 100 μA/cm². The device operated at 100 μA/cm² demonstrated efficient reaction kinetics of an Fe—CO₂ battery system with C-rate of C/2.5 operated for 2.5 hours of quick discharge.

Cyclic voltammetry was carried out (using a battery as described above with reference to FIGS. 9A-9D) to investigate the electrochemical redox reactions occurring at the air electrode surface. FIG. 10A represents the cyclic voltammetry analysis to investigate the electrochemical redox reactions occurring at the porous CNF electrode surface. FIG. 10B shows a diagram illustrating an enlarged version of cyclic voltammetry of the battery cell after 20^{th} cycle. During the first CV cycle (i.e., before charge-discharge of the cell), the cell showed distinct onset cathodic and anodic potentials of ˜1.1 and ˜0.9 V, respectively. The onset cathodic and anodic potentials indicate the CO₂ reduction reaction (CO_{2RR}) and CO₂ evolution reaction (CO_{2ER}), which is also observed in galvanostatic discharge-charge curve. After 20 charge-discharge cycles of the cell, the cell also shows onset cathodic and anodic potentials but inferior peak currents (cathodic and anodic) than the cell before charge-discharge. This inferior performance of the cell after 20 cycles relates to the material degradation over the cycling and can be correlated with electrochemical impedance spectroscopy (EIS). FIGS. 10C and 10D represent the Nyquist curve of the Fe—CO₂ battery operated at open circuit potentials (OCP) with a perturbation amplitude voltage of 10 mV in a frequency range from 0.01 Hz to 1 MHz. The cell showed resistance of the Fe⁺ transport through the electrolyte and electrode of 7 and 40Ω, respectively. After elapse of 20 galvanostatic discharge-charge cycles, the battery cell showed reasonable higher electrolyte and electrode resistance of 150 and 450Ω, respectively.

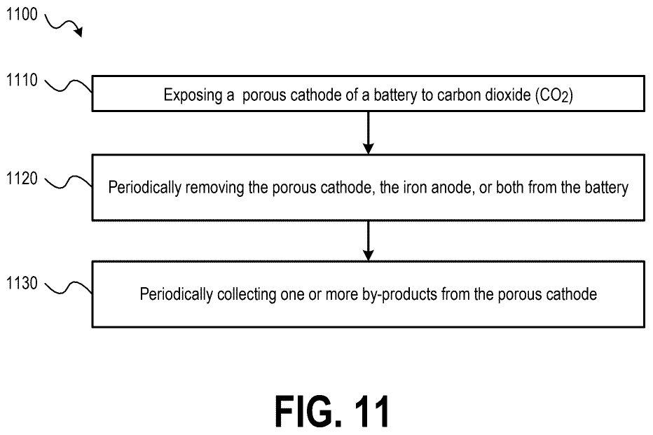

Referring to FIG. 11, a flow diagram of an exemplary method for generating electrical power using a battery in accordance with aspects of the present disclosure is shown as a method 1100. In an aspect, steps of the method 1100 may be performed by a power system, such as the power systems of FIGS. 1-4. At step 1110, the method 1100 includes exposing a porous cathode of a battery to CO₂. As explained above with reference to FIGS. 1-6 and 8, batteries in accordance with the present disclosure may include an iron anode (or anode formed from steel or an iron alloy) configured to produce Fe⁺. The battery is configured to produce electrical power based on generation of the Fe⁺ ions and chemical reactions between the Fe⁺ ions and the exposure of the porous cathode to CO₂. In addition to generating electrical power, the interaction between the Fe⁺ ions and the CO₂ at the porous cathode may be configured to produce one or more by-products, such as FeCO₃, H₂, carbon powders, or other by-products.

At step 1120, the method 1100 includes periodically removing the porous cathode, the iron anode, or both from the battery. As explained above with reference to FIGS. 2-3B, a new porous cathode may be provided for the battery while the porous cathode is removed, and a new iron anode may be provided for the battery while the iron anode is removed. For example, the cathode and/or anode may be removed using a conveyor system, as described above with reference to FIGS. 3A-3B.

At step 1130, the method 1100 includes periodically collecting the one or more by-products from the porous cathode. In an aspect, the one or more by-products may be processed to produce CH₄, as explained with reference to FIG. 7. Although not shown in FIG. 11, the method 1100 may also include refurbishing the anode while removed from the battery, at step 1120, as explained above.

As shown above, the present disclosure provides various configurations for CO₂-based energy conversion systems based on one or more Fe—CO₂ batteries. As can be appreciated from the examples described above, Fe—CO₂ batteries in accordance with the present disclosure may include porous cathodes (e.g., 3D CNF cathodes), which may be coated with a catalyst, and an anode formed from Fe, Fe-alloys, or steel, where the anode is connected to the cathode by electrolyte, as described above. The disclosed Fe—CO₂ batteries of the present disclosure enable direct CO₂ reduction by electron transfer on the (catalysts-deposited) cathode, thereby providing an efficient electrochemical energy conversion device for directly converting captured CO₂ into electrical energy without having additional energy consumption. Additionally, the disclosed CO₂ power systems enable generation of valuable by-products (FeCO₃, H₂, carbon powders, etc.) and/or processed in an energy efficient manner to generate valuable by-products (e.g., CH₄).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A system for conversion of carbon dioxide (CO₂) to energy, the system comprising:
an iron (Fe) CO₂ battery comprising:
an iron anode;
an electrolyte;
a porous cathode;
a catalyst;
a power output; and
a CO₂ introducer in fluid communication with a source of CO₂, the CO₂ introducer configured to provide CO₂ from the source of CO₂ to the porous cathode, wherein the Fe—CO₂ battery is configured to generate electrical power in response to providing CO₂ to the porous cathode via the CO₂ introducer.

2. The system of claim 1, wherein the iron anode comprises an iron alloy.

3. The system of claim 1, further comprising a means for refurbishing the iron anode.

4. The system of claim 3, wherein the means for refurbishing the iron anode comprises a conveyor belt.

5. The system of claim 1, further comprising a collection system for capturing one or more byproducts of a chemical reaction associated with the Fe—CO₂ battery.

6. The system of claim 5, wherein the one or more byproducts comprises iron carbonate (FeCO₃), carbon powders, hydrogen, methane, or a combination thereof.

7. The system of claim 5, wherein the one or more byproducts are formed on the porous cathode and partially on the anode.

8. The system of claim 1, wherein the source of CO₂ comprises a carbon capture source.

9. The system of claim 1, further comprising at least one additional Fe—CO₂ battery.

10. The system of claim 1, wherein the electrolyte comprises an aqueous electrolyte, wherein the aqueous electrolyte comprises iron (II) acetate, iron nitrate, iron chloride, iron sulfate, iron iodide, sodium chloride, potassium hydroxide, sodium hydroxide, or a combination thereof, and water as a solvent.

11. The system of claim 1, wherein the electrolyte comprises a non-aqueous electrolyte, wherein the non-aqueous electrolyte comprises ethylene carbonate (EC), tetraethylene glycol dimethylether (TEGDME), 1,3-dioxolane (DOL), 1,2-dimethoxyethane (DME), poly(ethylene glycol)dimethyl ether (PEGDME), diethylene glycol dibutyl ether (DEGDBE), sulfone, sulfolane, dimethyl carbonate (DMC), methylethyl carbonate (MEC), vinylene carbonate (VC), allyl ethyl carbonate (AEC), diethyl carbonate (DEC), ethyl propionate, methyl propionate, propylene carbonate (PC), acetonitrile (AN), 2-ethoxyethyl ether (EEE), ethyl acetate (EA), methyl formate (MF), toluene, methyl acetate (MA), ethylene glycol dimethyl ether, dimethyl cellosolve, dimethyl ether (PEGDME), diethylene glycol dibutyl ether (DGDE), fluoroethylene carbonate (FEC), or a combination thereof.

12. The system of claim 1, wherein the catalyst comprises a two dimensional (2D) transition metal dichalcogenides (2D TMDs) such as MoS₂, WS₂, MoWS₂ etc., Group II metal (such as alkaline earth, Be, Mg, Zn, Cd or Hg), Group IV metal/transition metals (such as Co, Ni, Cu, Ti, Zr, Hf, Ge, Sn or Pb), Group V metal (such as V, Nb, Ta, As, Sb or 13i), Group VIII metal (such as iron or platinum group), Group I (such as alkali, Ag, Au or Cu), other metal (such as Cr, Mo, Sc, Y, Al, Ga, In), and their oxides such as Mn₂O₃, ZnO, NiO, SiO2, TiO₂, WO₃, MgO, CaCO₃, ZrO₂, Al2O₃, Fe₂O₃, CO₃O₄, etc. and their sulfides such as CuS, PbS, TiS₂, WS₂, or derivatives thereof.

13. The system of claim 1, wherein the catalyst is deposited on the cathode.

14. The system of claim 1, wherein the cathode comprises a nanofiber material.

15. The system of claim 14, wherein the catalyst is deposited on the nanofiber material.

16. The system of claim 14, wherein the nanofiber material comprises a carbon nanofiber material.

17. A method comprising:
exposing a porous cathode of a battery to carbon dioxide (CO₂), wherein the battery comprises an iron anode configured to produce iron ions (Fe⁺², Fe⁺³), wherein the battery is configured to produce electrical power based on generation of the Fe ions, and wherein the Fe ions interact with the CO₂ at the porous cathode to produce one or more by-products;
periodically removing the porous cathode, the iron anode, or both from the battery, wherein a new porous cathode is provided for the battery while the porous cathode is removed and a new iron anode is provided for the battery while the iron anode is removed; and
periodically collecting the one or more by-products from the porous cathode.

18. The method of claim 17, further comprising processing at least one of the one or more by-products to produce methane (CH₄).

19. The method of claim 17, wherein the porous cathode, the iron anode, or both are removed using a conveyor system.

20. The method of claim 17, wherein the battery is configured to continuously produce electrical power.
